(19) United States
(12) Patent Application Publication
(10) Pub. No.: US 2011/0126122 A1
(43) Pub. Date: May 26, 2011

(54) SYSTEMS AND METHODS FOR GENERATING PROFILES FOR USE IN CUSTOMIZING A WEBSITE

(76) Inventors: George Forman, Port Orchard, WA (US); Evan R. Kirshenbaum, Mountain View, CA (US)

(21) Appl. No.: 12/623,221

(22) Filed: Nov. 20, 2009

(51) Int. Cl. G06F 3/048

(52) U.S. Cl. 715/745; 715/760

(57) ABSTRACT

Systems and methods are disclosed for constructing a profile that obtain text associated with web content. Logic instructions are provided by a party that is unaffiliated with a party that provides the web content to allow a profile associated with a user to include information from two or more web sites that are unaffiliated with one another. A match between the text and a target in a target set is detected. The profile associated with the user is modified based on the match.

### BACKGROUND

In most cases, web sites configure their entry pages to be broadly attractive to a large number of users and provide ways for the customer to navigate to their desired item by “drilling down” through sections of the site by browsing or by entering keyword or item number queries. There are two main disadvantages to this. First of all, a visitor to a site may be unaware that it actually carries the product that they are interested in and so do not bother to search. And second, keyword searches and drill-down navigation can be an inefficient process that causes potential customers to give up before they find the product on the web site.

Some web sites display “recommended” items. Typically, these recommended items are the same for all visitors and simply reflect products that are currently popular or are complementary to an item being viewed. In some cases, the recommendations may be targeted to specific users. Such targeting can be based on observations of the user's behavior when interacting with the site (e.g., products viewed, products purchased, and/or product ratings), possibly in combination with the behavior of other users who have looked at, purchased, and similarly rated the same (or similar) items.

### BRIEF DESCRIPTION OF THE DRAWINGS

Embodiments of the invention relating to both structure and method of operation may best be understood by referring to the following description and accompanying drawings.

FIG. 1 is a schematic block diagram illustrating an embodiment of an example system for customizing a website.

FIG. 2 is a flow diagram of an embodiment of an example process that can be included in customization logic of FIG. 1 to build target sets relevant to a particular user that represent products offered at one or more web sites.

FIG. 3 is a flow diagram of an embodiment of an example process that can be included in customization logic or browser program of FIG. 1 to note products/services a particular user has viewed at one or more web sites.

FIG. 4 is a flow diagram of an embodiment of an example process for customizing a web site.

### DETAILED DESCRIPTION

Web sites often serve content relating to items or entities that a user may be interested in. In this specification, such items or entities will be referred to as “potentially interesting items” (“PIIs”). Examples of potentially interesting items include, but are not limited to: products or services offered for sale, discussed, reviewed, or supported; off-line businesses or other entities discussed, linked to, or described; organizations such as charities, colleges and universities, or mailing lists, that may be joined or contributed to; athletic teams for which scores and schedules may be provided; geographic locales for which vacation, real estate, weather, or governmental information may be provided; subjects about which descriptions or news articles may be provided; and content objects such as specific articles, reports, manuals, programs, data sets, photographs, video files, or audio files. Within this specification, reference to any of these should be construed as applying to all.

Embodiments of systems and methods disclosed herein enable Web sites to customize their recommendations to users based not merely on a user's browsing behavior on that site but on other sites that talk about or offer similar potentially interesting items. Review sites (or other news sites) can push reviews, stories, or ads that are relevant for shopping for products or services the user has shown an interest in. User profiles are developed on a system that is not affiliated with a particular web site. Accordingly, web sites can receive information regarding a user's interests without any direct collaboration with the other sites the user interacts with. Users can remain anonymous to the site being customized. Interest in specific PIIs, generic PIIs, and PII categories can be inferred from a user's previous activity on the same or other websites. Extra network traffic is not created to infer the potentially interesting items and only minimally impacts the user's system performance.

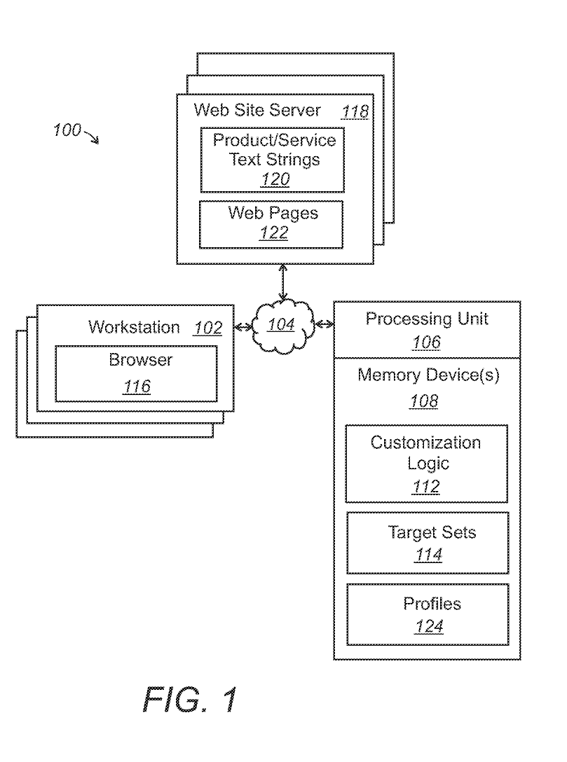

Referring to FIG. 1, an embodiment of a system 100 for customizing a website is shown. The embodiment of system 100 shown includes one or more user workstations 102 coupled through network 104 to communicate with processing unit 106. Processing unit 106 can be configured with or can remotely access user interface logic 110, customization logic 112, and target sets 114. For example, target sets 114 can be implemented in a remote data server (not shown) and accessed by processing unit 106 via network 104. Some or all of user interface logic 110 can be implemented in user workstations 102 instead of or in addition to processing unit 106.

Customization logic 112 can be implemented by a third party customization service provider and can include logic that can be executed by processing unit 106 to build target sets 114 corresponding to potentially interesting items, observe a user's browsing behavior and note when targets in the target set 114 are detected, and obtain targets relevant to a particular user and use the targets to customize a web site when the user invokes the web site. Targets can be associated with potentially interesting items, and can be text strings, bigrams, numbers, or other suitable information. There may be many targets associated with the same PII, and there may be more than one PII associated with a target. The term “content object” can refer to any form of digital content, such as news articles, photographs, movies, or product reviews, regardless of format (e.g. text, Microsoft Rich Text Format, Adobe PDF, Apple QuickTime movie, or Adobe Flash). A content provider is either a web site, or a third party that is used by a web site to fill in content in the final web page presented to the user, such as an external ad agency. No restriction to the claims is implied by these examples.

Workstation(s) 102 can include browser program 116 to allow users to communicate with processing unit 106 and various web site servers 118 over network 104. Browser program 116 can also provide a graphical user interface that is presented on display device to allow a user to interact with and view information from web site servers 118. Examples of suitable browser programs 116 are Internet Explorer from Microsoft Corporation (www.microsoft.com) and Firefox from Mozilla Corporation (www.mozilla.com), among others.

Web site servers 118 can be accessed by workstations 102 and processing unit(s) 106 via network 104. Web site servers 118 can host and implement electronic commerce sites that allow a user to view web pages 122 that render information on goods and/or services for sale to be displayed to a user. Web pages 122 may also allow the user to view additional detail, and order and pay for selected goods/services. Web site servers 118 can also host manufacturer/supplier web sites, independent third party review or catalog web sites, or other type of web site that provides information regarding various potentially interesting items available. Accordingly, web site servers 118 can maintain and provide a list of character strings 120 that uniquely identify the PIIs for which information is available.

The content and layout of the web pages 122 can be specified with a mark-up language, such as Hyper-text Mark-up Language (HTML). Based on the subset of matches between text in PII text strings 120 for a particular web page 122 and target sets 114, as well as text matches found as the user visits other web sites, a profile 124 of the matches can be created for the user by customization logic 112 taking into account time elapsed since a particular match was detected as well as the number of times a particular match is noted, as further described herein. Notably, customization logic 112 can accumulate information from a variety of web pages 122 to generate user profiles 124. A text string can be at least a portion of a text source such as at least one of: a title of web content, a markup language element of the web content, a header associated with a request for the web content, a keyword associated with the web content, text to be presented upon viewing the web content, and text to be presented in a contrastive manner upon viewing the web content. The term “contrastive manner” refers to text that is presented in a manner that is different from the rest of the text, such as text that is in bold font, italics, blinking, in a different color, highlighted, or any other suitable format for drawing attention to the text or presenting the text in a manner that is different from other text.

Although profiles 124 are shown in processing unit 106, profiles 124 can reside on workstation 102, processing unit 106, and/or a remote database (not shown) and accessed via network 104. Customization logic 112 and target sets 114 are provided by a party that is unaffiliated with the parties that provides the web pages 122 hosted by web site servers 118. This allows target sets 114 and profiles 124 to include information from many web sites that are unaffiliated with one another and are provided by different parties instead of just one or more web sites that are affiliated with or provided by a particular party. A party, also referred to as a content provider, may be an individual, an organization, or other entity that provides web content presented to users via web site servers. In this disclosure, web sites are considered unaffiliated with one another when the web sites do not share content with one another, and information presented to a user and/or received from a user on one web site is not shared with the other web site(s). Further, unaffiliated web sites may be operated by different ownership entities, for example, GOOGLE®, YAHOO!®, and CRAIGSLIST®.

Building the Target Set

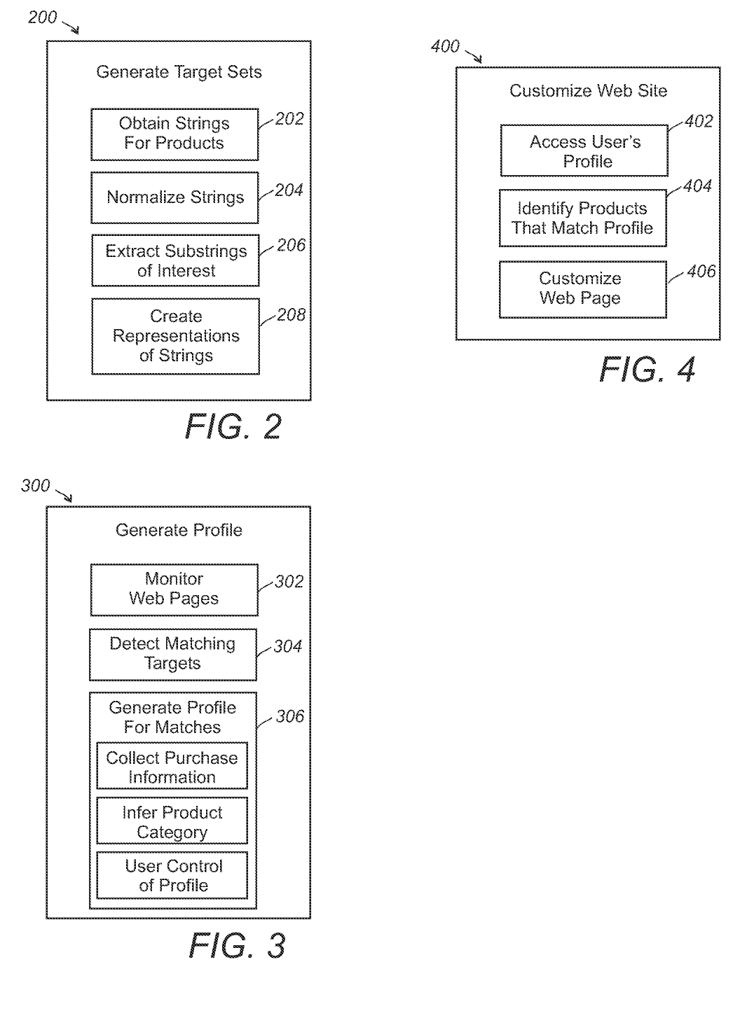

Referring to FIG. 2, a flow diagram of an embodiment of an example process 200 is shown that can be included in customization logic 112 (FIG. 1) to build target sets 114 (FIG. 1) relevant to a particular user that represent products offered at one or more web sites.

Process 202 can include obtaining one or more strings per product. The strings can be provided directly by the manufacturer/supplier and are often used by sellers' web sites. An example of a product string is “HP SL4778N 47-Inch 1080p MediaSmart LCD HDTV”. Such product strings may be solicited from suppliers, online stores, and/or may be provided as part of a partnership agreement between the web site and an entity providing customization service. The strings from sellers' web sites may also be augmented by strings from other sources such as encyclopedic web sites like IMDB (for movie titles), and lists of products from manufacturers' web sites, among others. The descriptive string may be a “proper name” of the product that is used to construct the title and/or headers for the web site's page dealing with the product.

In some cases, the product strings used in a particular web site may be found by “scanning” the web site's pages and noting the titles or other potentially important text. In such cases, it may be useful to process the titles, headings, or page text to exclude text that is essentially invariant over many pages. Such text may often be boilerplate such as the name of a store, navigation menus, or a “department” within the site. Such text may also include hosted advertising, links to other products, or customer- or user-supplied comments. Such exclusion may be made in many different ways. In some embodiments exclusion may based on models learned via machine learning techniques or rules generated by people The exclusions may be made based on the content of the included text or based on its position within the text. For sufficiently important sites, it may be worth manually constructing XPATH expressions or other forms of automatic rules for processing pages to accurately extract the names of products.

In some cases, the list of targets can include product names. In other embodiments, the product names may be more complex and annotated with other information such as an identifier (e.g., ISBN, SKU, or URL) that specifically identifies the product to a particular web site. Other information may include the type of product, the manufacturer, the price range (e.g., “high end”, “budget”), and an indicator of a generic product, among others. Such information may be hierarchical. For example, a product string may be increasingly specific: “electronics”, “home entertainment”, “TV”, “plasma”, “39-47 inch” and “HP SL4778N”. The hierarchy may be provided by the web site (and, therefore, specific to the web site) or may be provided by the customization service provider and shared among web sites. In the latter case, it may be necessary to obtain a mapping between the web site's class hierarchy and the customization service provider's hierarchy.

Process 204 can process the list of text strings to make it more likely that products will be noticed when a user's web browsing is monitored. First, the strings will likely be normalized, e.g., by removing punctuation and whitespace, converting letters to lowercase, mapping HTML entities (e.g., “&amp;” mapped to “&”), and converting accented characters to canonical form (or mapping them to unaccented characters). Text deemed “noise” (e.g., parentheses or brackets) may be removed or separate entries may be created with and without noise text. “Stopwords” such as “the”, “a”, and “of” may be removed. American/British spelling variants (e.g. “colour” for “color”) and known-common misspellings may be inserted. Other normalization techniques can be used in addition to or instead of the aforementioned techniques.

Process 206 can include extracting substrings of interest from the strings by using one or more suitable techniques such as running a multi-word window over the strings, comparing strings for substrings in common from the same web site as well as with strings from other web sites, and/or other suitable techniques. With respect to common substrings, customization logic 112 can determine an “edit distance” that detects similarity between two strings, allowing for the insertion, deletion, transposition, and/or replacement of words to allow variations in naming the same product between store web sites. Customization logic 112 can also attempt to determine or infer whether parts of a string represent descriptive attributes like size and color rather than the product name. If so, such parts can be removed or moved to another part of the string. Color determination can be made, for example, by noting that the same text (e.g., “(red)”) appears on unrelated products or by consulting a dictionary of such targets.

Once a list of target strings (the target set 114) has been determined for a particular user, process 208 can include creating a representation of the target set 114 for use when monitoring the user's behavior. In some embodiments, the target set 114 may be stored directly in a database. In other embodiments, performance can be improved by creating a compact data structure that can be transmitted to a user's workstation to efficiently determine strings that are in the target set 114 as the user is browsing web sites. To create a compact data structure, process 208 can include computing a hash of each of the strings. For example, the hash (or “hash code”) of each word and then the hash of each subset of contiguous words, as further described in the section “Noting Products Viewed” hereinbelow. One suitable hash technique is described in U.S. patent application Ser. No. ______ (Attorney Docket No 200802054-1) entitled “Systems and Methods for Fast Text Feature Extraction For Classification and Indexing”. Note that some or all of the process of normalizing the strings can take place while the hash code is being computed. Further, other suitable techniques for compacting the data can be used. A match between the text strings and the target strings can be detected using a moving window on the text of the web page content and comparing the hash codes against those of the target strings. For example, if a moving window of three words were used, a candidate hash code would be generated and compared based on the first through third words, then a second candidate hash code would be generated based on the second through fourth words, and so on. The term “moving window” can be a limited region of the text of the page that is tested for a match. This window is iteratively moved to successive (possibly but not necessarily overlapping) positions in the text, testing for a match at each position.

Noting Products Viewed

Referring to FIG. 3, a flow diagram of an example embodiment of a process 300 is shown that can be included in customization logic 112 (FIG. 1) or browser program 116 (FIG. 1) to note products/services a particular user has viewed from one or more web site servers 118 (FIG. 1) and build profiles 124 (FIG. 1). Process 300 can be performed by browser program 116. Alternatively, process 300 can be performed by a proxy (not shown), either running on user's workstation 102 (FIG. 1) or on a remote server used as a proxy. Either configuration allows the source for the web pages to be perused. Other suitable techniques for implementing process 300 can be used.

Process 302 monitors a user's interactions with web sites and the content of web pages accessed by the user, and identifies web page code of interest, such as names and/or other identifiers of products or services. For example, when the source text is HTML code, process 302 can detect a name/identifier of a product or service present in a “title” tag in HTML code, which is text that is typically displayed on the title bar of the web page on the user's browser window. Process 302 can detect information of interest from other code for the web page such as the text in an “h1” header tag, which is an HTML element for the first-level heading of a document, the layout of a web page, and/or text rendered in large or bold fonts on a web page. Process 302 can also distinguish between code of interest on the web pages and code that is “uninteresting”, for example, framing information on the web pages such as ads, comments, or links to other products that are typically not of interest and exclude such code from the text to be checked. The web pages can be generated by web sites that are unaffiliated with or independent of one another.

Once text to be checked has been extracted, process 304 determines whether the text matches any terms (also referred to as “targets”) in target set 114 for the web site. Matches may be detected immediately or multiple strings may be stored for later processing, either at a given time or when the host computer running process 304 has available processing cycles. The processing may take place on the user's workstation, and/or the strings may be transmitted (one at a time or in batch) to a remote location for processing.

To detect matching targets, substrings of the title can be checked. In some embodiments, possible subsets of contiguous words in the string are considered after removing stop words. In other embodiments, a maximum string length may be imposed, either the longest naturally-occurring target in target set 114 or an explicitly-imposed bound, e.g. all subsequences up to 12 words long. Other techniques further described herein may be used to narrow the number of substrings checked for matches.

If target sets 114 are stored in a database, each remaining substring can result in a database query. As an alternative, a compact representation of the hash codes of the target strings can be maintained and the hash of each substring can be computed. If the hash is stored in the data structure, process 304 can determine whether the substring matches a target in target set 114 even though the match may be a false positive result. Typically there is a trade-off between the false positive rate and the amount of space the data structure consumes, as well as the amount of time required to determine that a substring is or is not contained in the space.

In some embodiments, target set 114 can be maintained as a sorted array of 40-bit (i.e., 5-byte) hash codes. Smaller hash codes, (e.g. 4-byte (32-bit) hash codes) can be used but may have a higher false positive rate of reported matches. Larger hash codes (e.g. 6 bytes) can provide a significant improvement and allow increased amounts of data in the target sets while maintaining a low false positive rate. Although the number of bytes used to store hash codes can be extended indefinitely, the hash computation becomes more expensive when more than 8 bytes are used, and for any extension the amount of space consumed increases. To process a string, the string can first be converted to an array of hashes corresponding to each word in the string with stop words removed. Stop words can by detected and removed using a table of stop word hash codes. Then for each possible starting position in the array, a hash code is computed for each possible subsequence of hash code in the array by successively combining hashes by a shift and XOR. Each subsequent candidate hash corresponding to a normalized substring of the title can be compared to entries in target set 114 to determine whether there is a match.

The lookup table for target set 114 may be kept as a dense, sorted array of hashes and the lookups performed by means of a proportional variant of a binary search. That is, rather than choosing a probe point in the midpoint of the active section of the table, process 304 can make use of the fact that the hash routine can produce essentially uniformly-random numbers to choose as the probe point according to the following Equation 1:

$$min + \frac{h ( t ) - h ( min )}{h ( max ) - h ( min )} ( max - min ) \qquad Equation 1$$

Iterating and setting “max” or “min” to just beyond the probe point until either the value at the probe point matches the target or max and min collide. Using Equation 1 a match is detected (or noted to not be detected) by iteratively probing the target set with the probe point based on the magnitude of a candidate hash code (h(t)). Empirically, Equation 1 can require an average of approximately four probes to find a match and another half probe on average to find a miss for tables consisting of millions of entries.

Other representations of target set 114 can be used including normal hash tables.

Once a match has been found as being, for example, from word 4 to word 7 of the title, the substring of the title that the match corresponds to is noted. The substring can be normalized or raw including all ignored symbols and stop words. After the title is processed, the set of matches may be reduced to a subset of “best matches”, a single best match, or a set of “good enough matches” by considering the number of words matched and the length of the string. In some embodiments, there can be metadata that indicates that some targets are more important than others, and this information can be used in making the decision of whether a match has been found.

Based on the subset of matches for a particular web site, and matches found as the user visits other web sites, process 306 can generate or modify a profile 124 (FIG. 1) of the matches taking into account time elapsed since a particular match was detected as well as the number of times a particular match is noted. The profile can include the names of targets (or names of the potentially interesting items the targets are associated with) and/or representations of the names of the targets or PIIs. Representations of the names of the targets or PIIs can include hash values computed based on the names or other suitable representations. In generating the profile, matches may be compared with one another for similarity, such as when the same product is matched on multiple sites but described slightly differently on each. Also, if there is information about categories associated with a matched product, support can be inferred for the general category and sub-category. For example, if a user visits sites for several different models of TV, the general “TV” and “home entertainment” categories can be supported, and if a user browses sites talking about cat food and cat litter, customization logic 112 may infer support for a more general category of “pet supplies—cat”. In some embodiments, the categories associated with products may form one or more hierarchies, with more specific categories being considered to be descendents of more general categories. Categories associated with products may include not only the type of product but also, without restriction, other attributes such as price (or price range), applicability of special offer, popularity, customer rating, size, capacity, availability, manufacturer, or target customer market segment (e.g., age, sex, or income level). For other sorts of potentially interesting items, other types of category may apply.

Process 300 can obtain further texts and detect matches with further targets associated with further potentially interesting items associated with further categories. A subset of categories to include in the first profile can be generated based on the further matches. For example, process 300 can determine that a first item is associated with several categories (e.g., “electronics”, “home theater”, “televisions”, “LCD televisions”, “40-inch televisions”, “1080p televisions”, “items costing between $700 and $1,000”) and the other items are associated with other categories, where there may be overlap between the categories associated with different items. From the set of categories, process 300 can determine that the appropriate categories to describe the user's interest are “LCD televisions” and “1080p televisions”, as other televisions viewed may be in different size and price ranges. Perhaps based on the other items, process 300 might narrow the categories to “40-inch televisions” and “42-inch televisions”. Such a technique can be used to categorize and subcategorize other types of items, such as information on books the user has viewed.

In some embodiments, a first profile identifies products, services, organizations, subjects, and/or content objects of interest to the user. A second user profile can be used to identify a category based on the user's first profile. For example, the first profile can be used to determine the specific number and type of item a user has viewed whereas the second profile can be used to provide more general information about the user's interest.

Process 306 may be performed on the user's workstation 102 (FIG. 1), unless it is impractical to download category and sub-category information for every target hash or to compute complex similarity metrics. If the profile is to be generated on user's workstation 102, it may be desirable to have the user's workstation 102 contact a central server to obtain metadata for the hashes or the strings that led to them for each match found. Alternatively, user's workstation 102 may upload the target sets and a central server can modify the profile. For example, a central server could expand the match for hash 0x78F38B2C82192340 into the original product title and/or hierarchical attributes of the product. Alternately, the matching text substring of the title could be uploaded to the central server, and the substring could be analyzed in similar ways to determine the attributes of the product.

One goal of customization logic 114 is to identify products that a user is actively shopping for, in addition to noting that the user has viewed pages that deal with the product (e.g., retail store pages or review sites). It may also be desirable to be able to infer that the user has not already purchased the product or a substitute for the product. Process 306 can allow the inferred interest in a particular product to decay over time, since if there is a flurry of shopping behavior for a particular product or product category and then the activity ceases, it can be inferred that the user is no longer interested in buying that product. However, especially for recent interest, it may be desirable to notice when a user makes an on-line purchase. Purchases can be detected, among other ways, by noting that the user has followed a link whose accompanying text or URL indicates a purpose to add something to a shopping cart or that the resulting page indicates that something has been added or immediately purchased. In such cases, the product matched on the immediately preceding page can be inferred to have been purchased, and the product matched and any products that appear to be similar should probably be removed from the profile. Removing the product from the profile can prevent continually offering advertisements or other information for products/services that were once of interest but are no longer needed. Alternately, the product/service can be marked as ‘recently purchased’ and accessories appropriate to the product may be promoted by participating online stores.

In some embodiments, process 306 may not only note that a product has been viewed but also to try to extract the price of the product from the viewed web page. Price information can be used in several ways. For example, the store web site being customized may be able to dynamically modify its offering price based on the knowledge of competing prices the customer has seen, even if it is not revealed where the customer saw them. Second, a web site may refrain from showing the user a product that it carries if it knows that the user has already seen a better price. Further, the knowledge of the prices seen for products in a category may allow the web site to decide which products in a category to display.

In some cases, the same target may appear associated with multiple disjoint categories. For example, the same product name may refer to a book, a movie, a CD, and a video game, and other coordinated merchandising. When such a product is matched, process 306 may infer the product category from the web site based on the name of the web site and/or by other product matches on the web site. This is one instance in which it might be useful to try to extract matches from the entire web page, including other products recommended. Note that if category information is not being used, this is needless—the product name is simply the product name.

Process 306 can also allow the user to control their profile. Examples of such control might include (1) a “pause button”, to allow a user to indicate that the products or web pages viewed should be included in the user's profile, (2) an option to exclude products in certain categories or matching certain patterns, and/or (3) the ability for a user to view their profile and explicitly remove items, optionally with the further ability to permanently prevent the product from being added to the profile in future browsing.

Customizing a Web Site

Referring now to FIG. 4, a flow diagram of an embodiment of a process 400 for customizing a web site is shown. In order for a web site to make use of the information collected/generated in processes 200 (FIG. 2) and 300 (FIG. 3), process 402 accesses a user's profile. In some embodiments, the profile can be stored on the user's workstation and the user sends the profile as part of a HTTP request or other request to obtain content. Alternatively, the web site can obtain an identifier for the user and request the profile from a third party. Such an identifier might be a user name or other stable token for the user on the profile server or, if anonymity is a consideration, the identifier can be a one-time encryption of a user identifier along with a blinding factor, where only the profile server is capable of decrypting the encrypted token to extract the user identifier. The user will typically begin a session with the web site and the web site can continue using the encrypted identifier (and request profile updates) as long as the session lasts.

The profile can take many forms. In some embodiments, the profile includes strings that were matched, perhaps in normalized form. In such a case, the web site can use its own search facility to identify likely products that match those strings. In cases in which the profile can associate targets with categories, process 404 can prune the profile to matches of targets in categories for which the web site has products. Although some examples herein pertain to the web site being a store, similar features can be included when the web site is a product review or product news site or any other web site that may have product-related content. For sites that have products in multiple categories, process 404 can identify the categories of the targets matched to prevent spurious recommendations of unrelated products, such as, for example, a book whose title happens to match the name of a car being viewed. However, some matches in different categories may be appropriate to present, such as merchandise related to a particular product such as a toy, book, CD, or DVD.

In some embodiments, rather than including the strings, process 404 can include the web site's own product identifiers and categories in the profile, as provided by the web site when the target set 114 (FIG. 1) was created. Process 404 can match each target including those of other web sites to the nearest matches for this web site. When the profile is requested, the strings it contains can be mapped to the matching products and categories and the result transmitted to the web site. Alternatively, if the profile is kept on the user's workstation, the transmitted profile may include the hashes of the targets matched. To send hash codes, a similar mapping can be created when the target set 114 is compiled, and a mapping from hash codes to product identifiers is transmitted to the web site. When the web site obtains a profile, the website looks up the hash codes in the mapping to find the products and categories.

Process 406 can use any of various techniques to customize the web page. In some embodiments, process 406 can take the form of altering the set of products proffered as recommendations on the initial page the user sees or kept in a side-bar on pages as the user browses. In some cases, specific products are not recommended but the user is immediately directed to a web page for the relevant “department” of the web site. Alternatively, navigation to the relevant department is made more visually obvious.

In some embodiments the web site is the provider of the content used to customize the web page. In alternative embodiments, the web site can request personalized content from an external content provider. In some such embodiments, the web site may forward the profile to the external content provider. In other such embodiments, the web site may forward the identifier for the user to the external content provider and the external content provider may use the identifier to obtain the profile from the profile server.

In some cases, the web site may want to be more proactive in drawing users. In such cases, process 406 may display information when it is inferred that the user is looking at a product page. Such information can include a link to the product (or category) on the store's web site and may include pricing information. The display may appear in a pop-up window or a stable section of the web page display. The information can also be provided in an RSS feed, an e-mail advertisement, or other suitable communication to the user. Accordingly, process 406 can include allowing users to customize the information that is sent to them, such as allowed sources, contact means, and content.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs and logic instructions can be embodied in a computer-readable storage medium or device for use by or in connection with an instruction execution system, device, component, element, or apparatus, such as a system based on a computer or processor, or other system that can fetch instructions from an instruction memory or storage of any appropriate type.

In FIG. 1, user workstations 102, processing unit 106, and servers 118 can be any suitable computer-processing device that includes memory for storing and executing logic instructions, and is capable of interfacing with each other and other processing systems via network 104. In some embodiments, workstations 102, processing unit 106, and servers 118 can also communicate with other external components via network 104. Various input/output devices, such as keyboard and mouse (not shown), can be included to allow users to interact with components internal and external to workstations 102, processing unit 106, and servers 118. User interface logic 110 can present screen displays or other suitable input mechanism to allow a member of the first group to view, enter, delete, and/or modify ratings for members of the second group. Additionally, predicted ratings for a member of the first group may also be presented to the user via a screen display or other suitable output device. Such features are useful when presenting recommendations to the user or other information that predicts the level of interest a user may have in a particular member of a second group.

Additionally, workstations 102, processing unit 106, and servers 118 can be embodied in any suitable computing device, and so include servers, personal data assistants (PDAs), telephones with display areas, network appliances, desktops, laptops, or other computing devices. Workstations 102, processing unit 106, servers 118, and corresponding logic instructions can be implemented using any suitable combination of hardware, software, and/or firmware, such as microprocessors, Field Programmable Gate Arrays (FPGAs), Application Specific Integrated Circuit (ASICs), or other suitable devices.

Workstations 102, processing unit 106, and servers 118 can include memory devices 108, although memory device 108 is only shown in processing unit 106. Logic instructions executed by workstations 102, processing unit 106, and servers 118 can be stored on a computer readable storage medium or devices 108, or accessed by workstations 102, processing unit 106, and servers 118 in the form of electronic signals. Workstations 102, processing unit 106, and servers 118 can be configured to interface with each other, and to connect to external network 104 via suitable communication links such as any one or combination of T1, ISDN, or cable line, a wireless connection through a cellular or satellite network, or a local data transport system such as Ethernet or token ring over a local area network. Memory devices 108 can be implemented using one or more suitable built-in or portable computer memory devices such as dynamic or static random access memory (RAM), read only memory (ROM), cache, flash memory, and memory sticks, among others. Memory device(s) 108 can store data and/or execute customization logic 112, target sets 114, profiles 124, browser program 116, product/service strings 120, and information associated with web pages 122.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. The illustrative techniques may be used with any suitable data center configuration and with any suitable servers, computers, and devices.

What is claimed is:

1. A system for constructing a profile comprising:
logic instructions embodied in a computer-readable storage medium and executable on a computer processor to cause the computer processor to:
obtain text associated with web content, the logic instructions are provided by a party that is unaffiliated with a party that provides the web content to allow a first profile associated with a user to include information from two or more web sites that are unaffiliated with one another;
detect a match between the text and a target in a target set; and
modify the first profile associated with the user based on the match.

2. The system of claim 1, wherein the logic instructions are further configured to provide at least a portion of the first profile in conjunction with a request for a content object.

3. The system of claim 1, wherein the logic instructions are integrated with a web browser.

4. The system of claim 1, wherein the logic instructions are further configured to provide at least a portion of the first profile in response to a request.

5. The system of claim 1, further comprising:
the target associated with a potentially interesting item.

6. The system of claim 5, wherein the potentially interesting item is one of the group consisting of: a product, a service, an off-line business, an organization, an athletic team, a geographic locale, a subject, and a content object.

7. The system of claim 5, further comprising the first profile is indicative of an interest of the user.

8. The system of claim 5, further comprising:
the first profile includes at least one of the name and a representation of the name of the potentially interesting item.

9. The system of claim 5, wherein the first profile contains a category associated with the potentially interesting item.

10. The system of claim 9, wherein the logic instructions are further configured to cause the computer processor to:
obtain further texts and detect matches with further targets associated with further potentially interesting items associated with further categories; and
compute a subset of categories to include in the first profile.

11. The system of claim 1, further comprising:
the first profile identifies a potentially interesting item; and
a second profile identifies a category based on the first profile.

12. The system of claim 1, wherein the text is at least a portion of a text source, the text source being at least one of the group consisting of:
a title of the web content, an HTML element of the web content, a header associated with a request for the web content, a keyword associated with the web content, text to be presented upon viewing the web content, and text to be presented in a contrastive manner upon viewing the web content.

13. The system of claim 1, wherein obtaining the text comprises excluding a portion of a text source.

14. A computer-implemented method of generating a profile for customizing a web site comprising:
monitoring web site content from at least two web sites, the web sites are unaffiliated with one another;
detecting a text string of interest in the web site content;
determining whether the text string matches a target associated with a potentially interesting item;
determining based on a match between the text string and the target, that the potentially interesting item represents an item of interest to the user;
modifying a profile based on the match between the text string and the target; and
allowing the profile to be accessed over the computer network to customize web pages browsed by the user.

15. The method of claim 14, further comprising:
providing the profile to a content provider.

16. The method of claim 14 further comprising:
the potentially interesting item is one of the group consisting of: a product, a service, an off-line business, an organization, an athletic team, a geographic locale, a subject, and a content object.

17. The method of claim 14 further comprising:
the target is a hash code computed from a text string; and
detecting a match includes:
computing candidate hash codes using a moving window and
comparing the candidate hash codes against the potentially interesting item.

18. The method of claim 14 further comprising:
generating a target set represented as a sorted list of potentially interesting items; and
detecting a match includes iteratively probing the potentially interesting items set based on a magnitude of a candidate hash code.

19. A method comprising:
in a first computer:
monitoring web site content from at least two web sites browsed by a user over a computer network, the web sites are unaffiliated with one another;
detecting a text string of interest in the web site content;
determining whether the text string matches a target associated with a potentially interesting item;
modifying a profile based on a match between the text string and the target; and
allowing the profile to be accessed over the computer network to customize web pages browsed by the user.

20. The method of claim 19, further comprising:
providing the profile to a content provider.
